(19) United States
(12) Patent Application Publication
(10) Pub. No.: US 2003/0013487 A1
(43) Pub. Date: Jan. 16, 2003

(54) Memory dialing method for telephone

(76) Inventor: Won-Il Joo, Bucheon (KR)

Correspondence Address: OSTROLENK FABER GERB & SOFFEN, 1180 AVENUE OF THE AMERICAS, NEW YORK, NY, 100368403

(21) Appl. No.: 10/204,340

(22) PCT Filed: Feb. 19, 2001
(86) PCT No.: PCT/KR01/00247

(30) Foreign Application Priority Data
Feb. 24, 2000 (KR) 2000/9062

(51) Int. Cl. H04M 1/00; H04B 1/38

(52) U.S. Cl. 455/558; 455/564

(57) ABSTRACT

A memory dialing method for telephone is disclosed to ensure a simple and rapid dialing in case that a user depresses numerous buttons to make a domestic call or an international call through a telecommunication company. An abbreviated phone number is recorded in a phone card to thereby directly use the abbreviated dialing or an abbreviated phone number assigning key portion of a phone number and the remaining numbers of the phone number are stored in a different ROM card which is attached and detached to/and from a phone set to thereby make an abbreviated dialing. Thus, the memory dialing method for telephone can be performed at a low cost without any inconvenience.

### TECHNICAL FIELD

The present invention relates to a memory dialing method for telephone, and particularly, to a memory dialing method for telephone by which a user is able to dial in simple and fast way in case that the user calls an international or domestic telephone call through a telecommunication company, and therefore the user should push many buttons.

### BACKGROUND ART

In a general telephone, there is a memory dialing function, that is, a user stores frequently used local or long distance telephone numbers in a memory and when the user pushes a certain button, then a telephone number stored in the corresponding region is called.

Recently, respective communication companies sell pre-paid telephone cards in order to obtain more customers, and the dialing process of long distance and international calls (for example, from the interior to the other country) using this telephone card will be described as follows.

1) dialing a long distance call: inputting the following sequentially, connect number of the telecommunication company (00xx) [symbol] card number (xxx-xxxx-xxx+#) [symbol] local number [symbol] number of the other part (xxx-xxxx+#).

2) dialing an international call: inputting the following sequentially, connect number of the telecommunication company (00xx) [symbol] card number corresponding an ID (identification) (xxx-xxxx-xxx+#) [symbol] communication connect number (for example, number of Korea Telecom; 001 ) [symbol] country code [symbol] phone number of the other part (xxx-xxx-xxxx+#).

As described above, if the user calls using the telephone card sold by the telecommunication company, the user should input the connect number of the telecommunication company and the card number written on the telephone card, whereby the telecommunication company is able to set a billing system.

In case that the user uses the telephone card, the user may feel some inconvenience by inputting the additional buttons. However, it has advantages that the telecommunication company is able to obtain more customers comparing to the competitive companies, and the user is able to call using the telephone card less expensive than usual phone.

However, in case that the user calls by the telephone of the conventional art using the pre-paid telephone card sold by the telecommunication company, the user should input many additional buttons whenever the user makes a call. Therefore, there may be some inconvenient features in spite of the advantage that the fee is very cheap.

### DETAILED DESCRIPTION OF THE INVENTION

Therefore, an object of the present invention is to provide a memory dialing method which make a call rapidly and simply in case that a user makes a domestic or an international phone call using pre-paid telephone card sold by telecommunication company.

To achieve the object of the present invention, there is provided a memory dialing method comprising: a first step in which the user inserts the telephone card having a memory concentrated element and fabricated so as to be attached and detached to/from the telephone and set a store menu, after that, the user inputs the connect number of the telecommunication company, language select number for voice guide message, and the number of the telephone card; a second step in which the respective numbers inputted in the first step are written in the memory concentrated element of the telephone card and a waiting time is set for outputting the voice guide message; and a third step reading the phone number stored in a certain button when the button is pushed, and transmitting a DTMF (Dual-Tone Multi Frequency) signal corresponding the number stored in the button to an exchanger.

To achieve the object of the present invention, there is provided another memory dialing method for telephone comprising: a first step wherein a telephone card on which a memory concentrated element is installed and fabricated so as to be attached and detached to/from the telephone is inserted in the telephone, setting a store menu, after that the connect number of the telecommunication company and the number of the telephone card are inputted, whereby recorded in the memory concentrated element of the telephone card, then setting a waiting time for voice guide message; a second step being inputted a special key and the telephone number of counterpart by the user and recording them on a ROM (Read Only Message) card; a third step when a memory button is inputted against the ROM card, reading the numbers recorded in the first step based on the special keys recorded in the second step, and generating corresponding DTMF signal, after that generating the DTMF signals corresponding to the numbers recorded in the second step continuously.

### BRIEF DESCRIPTION OF THE DRAWINGS

FIG. 1 is a block diagram of a telephone applied by a memory dialing method according to the present invention;

FIG. 2 is an outer sketch of the telephone applied by a memory dialing method according to the present invention;

FIG. 3 is an another outer sketch of the telephone applied by the memory dialing method according to the present invention;

FIG. 4 is a flow chart showing a signal flowing of the memory dialing method according to the present invention; and

FIGS. 5A and 5B are flow charts showing another signal flowing of the memory dialing method according to the present invention.

### MODE FOR CARRYING OUT THE PREFERRED EMBODIMENTS

The present invention will now be described with reference to accompanying drawings.

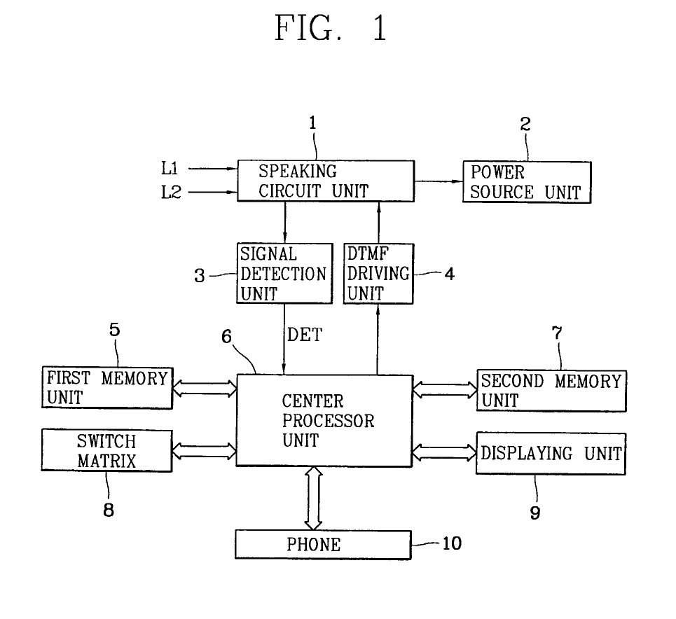

FIG. 1 is a block diagram of a telephone applied the memory dialing method according to the present invention.

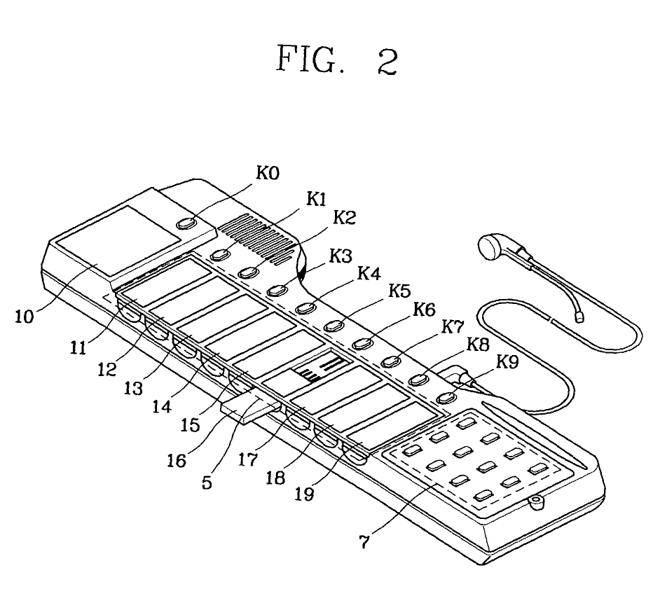

As shown therein, the telephone comprising a first memory unit 5 including a plurality of ROM (Read Only Message) cards and storing abbreviated numbers for memory dialing; a second memory unit 7 for storing a plurality of memory phone numbers as same form as in usual telephone; a center processor unit 6 dialing the corresponding phone number by driving a DTMF driving unit 4 according to key signal inputted from a switch matrix 8 by the user, and memory dialing using the first memory unit 5 and the second memory unit 7; a display unit 9 performing a usual displaying function and a handset 10 for talking; a DTMF driving unit 4 generating the DTMF (Dual-Tone Multi Frequency) signal corresponding the telephone number according to the controlling signal of the center processor unit 6; a speaking circuit unit 1 transmitting the DTMF signal to the exchanger through local loops (L1 and L2) and processing a voice signal so as to be able to talk with others; and a power unit 2 supplying voltage to the respective units by separately detecting the power source from the local loops (L1 and L2). The operation of the present invention described above will be described with reference to FIG. 2 through FIG. 5.

FIG. 2 is an outer sketch of the telephone applied by the memory dialing method according to the present invention.

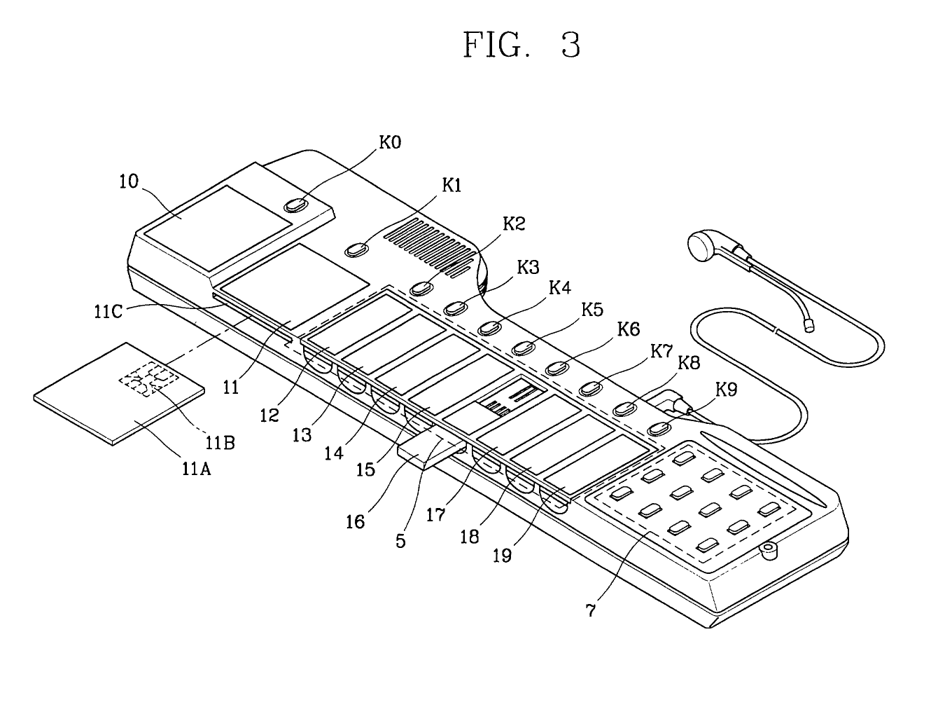

FIG. 3 is an another outer sketch of the telephone applied by the memory dialing method according to the present invention.

The structure of the telephone is applied by the structure of the telephone of Utility model number 4250, Korea patented Mar. 17, 1999.

That is, the telephone in FIG. 1 is similar with the integrated telephone in FIG. 6 of the Utility model number 4250.

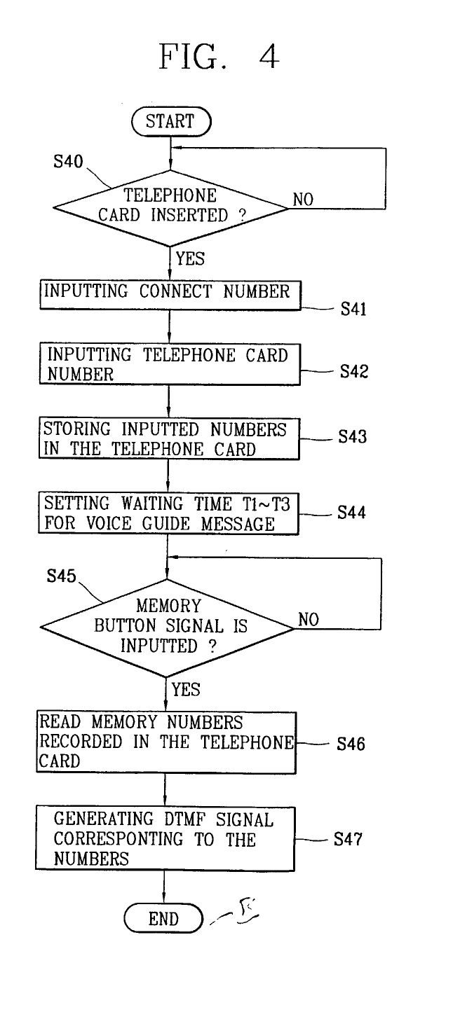

Herein, the first memory unit 5 and the second memory unit 7 are corresponding to first memory unit 45 and the second memory unit 46 in FIG. 4 of Utility model number 4250.

In FIG. 1, the first memory unit 5 includes a plurality of removable ROM card inserting units, on which ROM cards is inserted, on main body of the telephone as in FIG. 2 through FIG. 5 of the Utility Model 4250. And corresponding hot keys are disposed around the ROM card inserting units, whereby the memory dialing can be made easily.

Also, the second memory unit 7 in FIG. 2 includes a plurality of hot keys and memory regions corresponding to the hot keys.

In other words, the telephone shown in FIG. 1 applied by the memory dialing method according to the present invention is an integrated telephone having same structure as that in FIG. 2 through FIG. 5 of the Utility Model number 4250.

However, in the present invention, a ROM card 11 among those plurality of ROM cards 10˜19 in the first memory unit 5 is able to use a pre-paid telephone card sold by a telecommunication company, whereby a long distance or an international phone call is able to be made more easily.

Hereinafter, a process of memory dialing by recording the connect number of the telecommunication company and the card number on the telephone card 11 will be described with reference to FIG. 4 as follows.

FIG. 4 is a flow chart showing an embodiment of signal flowing of the memory dialing method according to the present invention. The memory dialing method by recording the connect number of the telecommunication company and the card number on the telephone card 11 will be described with reference to FIG. 1 through FIG. 3.

First, the center processor unit 6 is able to perform the memory dialing function by storing and reading the memory telephone number by the user's request on the telephone card such as storing and reading the telephone number stored in the ROM cards 12˜19 in the first memory unit 5.

The telephone card is inserted into the inserting unit (S40), and push the input/end key installed on the switch matrix 8, and then the store mode is set.

In the state, a hot key K1 installed around the telephone card 11 is pushed, then the address for the telephone card 11 is set.

In that state above, the connect number of the telecommunication company (for example, 02-397-7777) is inputted using number keys installed on the switch matrix 8 (S41). At that time., the center processor unit 6 identifies the connect number and records the connect number on the telephone card 11. In addition, the center processor unit 6 sets a certain waiting time T1 for voice guide message.

After that, when a corresponding language is chosen (for example, Korean 1, English 2, Japanese 3, and Chinese 4), the center processor unit 6 identifies the language select number, records it on the telephone card 11, and sets a certain waiting time T2 for voice guide message.

In addition, the card number (for example, 9 numbers+#) of the telephone card is inputted (S42). At that time, the center processor unit 6 identifies the card number, records(stores) the card number on the telephone card 11 (S43), and sets a certain waiting time T3 for voice guide message (S44). Then the store mode is ended.

In addition, the process described above may be performed twice, whereby two memory telephone numbers are stored in that telephone card 11. In that case, the hot key K1 is pushed shortly in order to set a store region for one memory telephone number (for example, connect number and the card number), and the other hot key K1 is pushed longer in order to set a store region for the other memory telephone number.

As described above, the process of recording the connect number of the telecommunication company, language select number, and the card number on the telephone card 11 may be performed by the user. However, it is desirable that the distributor of the telephone card 11 (for example, the telecommunication company or the telephone card selling company) records that information on the telephone card 11 as a customer service.

After the memory telephone numbers are stored in the telephone card, if the user wants to make a domestic or an international call using the telephone card 11, the user inserts the telephone card 11 into the inserting unit and pushes the hot key K1 installed around the inserting unit (S45). At that time, the center processor unit 6 reads the connect number of the telecommunication company from the telephone card 11 (S46), drives the DTMF driving unit 4, whereby the DTMF signal corresponding to the connect number is generated (S47). The DTMF signal is transmitted to an exchanger through the speaking circuit unit 1 and the local loops L1 and L2.

In addition, during the waiting time T1 set earlier in the record mode, voice guide messages of “please select your language” are outputted in some languages. At that time, the center processor unit 6 reads the language select number from the telephone card 11 and drives the DTMF driving unit 4, whereby the DTMF signal corresponding to the language is generated and transmitted through the above process.

Therefore, a voice guide message is outputted during the next waiting time T2 in the selected language (for example, in Korean), such as “please input your card number”. At that time, the center processor unit 6 reads the card number from the telephone card 11 and drives the DTMF driving unit 4, whereby the DTMF signal corresponding to the card number is generated and transmitted through the above process.

The connect number of the telecommunication company, the language select number, and the card number are automatically outputted through the above process, after that a voice message is outputted during the next waiting time T3, such as “please input the telephone number of the receiver”. At that time, the user is able to talk with counterpart by performing the dialing process.

For example, if the user wants to make a domestic call, the user is able to talk by dialing the local number and the telephone number of the other. And if the user wants to make an international call, the user dials country code (for example, 1), local number (123), and the phone number of the other (123-4567), and then is able to speak to the other.

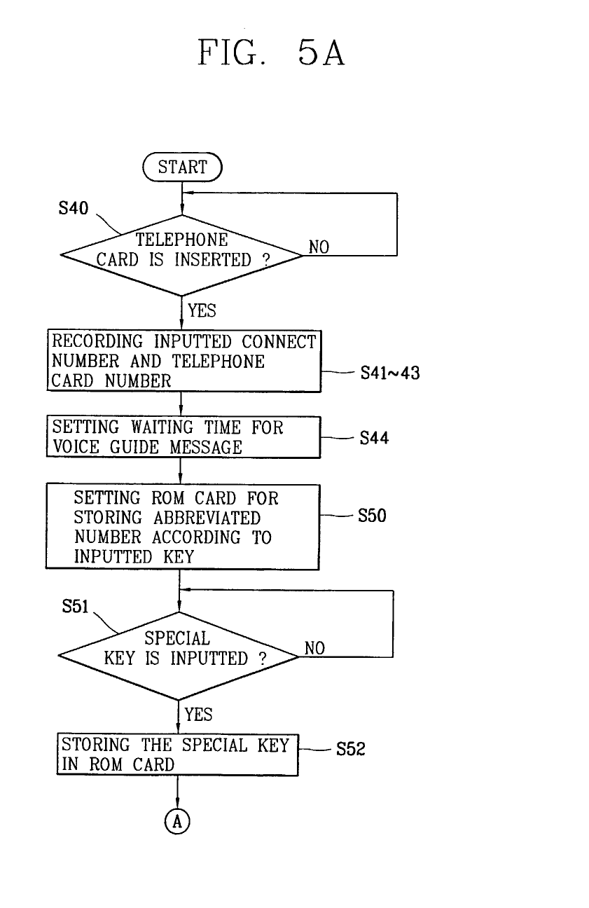

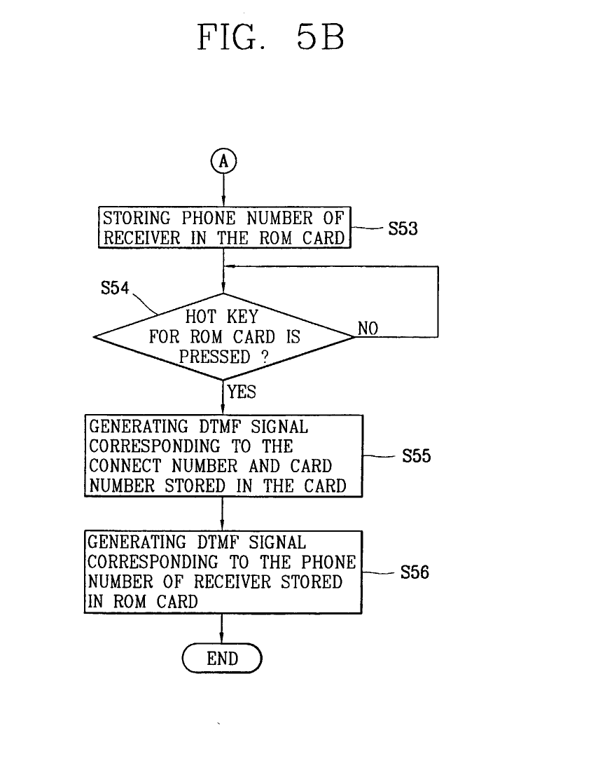

On the other hand, as for another embodiment of the present invention, a method of memory dialing an entire number using a hot key when the user makes a domestic or an international call will be described with reference to FIGS. 5A and 5B.

FIGS. 5A and 5B are flow charts showing the signal flowing of the another embodiment of the memory dialing method according to the present invention. The present embodiment will be described in detail with reference to FIG. 1 through FIG. 3. In addition, as for the processes (S40˜S44) same as in FIG. 4, same reference numerals are used, and descriptions for that are omitted.

First, the storing process will be described. The user presses the input/end key installed in the switch matrix 8, whereby the store mode is set. In that state, in order to set a ROM card in which the memory telephone number will be stored among ROM cards (12˜19) of the first memory unit 5, the user presses the corresponding hot key. That is, the user set the ROM card in which the abbreviated number will be stored according to the inputted key (S50).

After that, the user inputs a special key (‘*’ or ‘#’) for setting the ROM card 11 (S51) so as to automatically transmit the connect number of the telecommunication company and the telephone card number stored in the telephone card 11 when memory dialing is made.

In addition, the user inputs the remaining numbers. That is, the special key is stored in the ROM card (S52). For example, if the phone number which the user wants to store for the memory dialing is domestic number, the user inputs local number [symbol] telephone number of the receiver +#, and presses input/end key. Also, if the number which the user wants to store for the memory dialing is an international phone number, the user inputs country code [symbol] local number [symbol] telephone number of the other +#, and presses the input/end key.

The user is able to store the abbreviated number as he/she wants in the respective ROM cards 12˜19 of the first memory unit 5 by repeatedly performing the above processes (S53), and presses the hot key installed the corresponding ROM card, whereby the memory dialing is made (S54). The memory dialing process will be described as follows.

At that time, the center processor unit 6 reads the abbreviated number stored in the corresponding ROM card of the first memory unit 5. In the store mode, the telephone card 11 is set as special key (‘*’ or ‘#’), and therefore the connect number of the telecommunication company and the card number is read, after that the corresponding DTMF signal is generated and transmitted to the exchanger (S55).

And then, the abbreviated number read from the corresponding ROM card 12 of the first memory unit 5 is transmitted. For example, if the number after the ‘*’ or ‘#’ stored in the ROM card is a domestic number, the local number and the phone number +# are read, and the corresponding DTMF signal is outputted. If the number is an international call number, the center processor unit 6 reads the country code, local number, and the phone number+#, and outputs corresponding DTMF signal, whereby the phone call is made (S56).

That is, as described above, the numbers dialed whenever the telephone card is used, that is the connect number of the telecommunication company and the card number are stored in the telephone card 11, and the numbers are memory dialed using the corresponding hot key K1. Also, the numbers stored in the telephone card 11 is set as a special key ‘*’ and stored in a ROM card among the ROM cards in the first memory unit 5 or in a memory region on the second memory unit 7, and the remaining numbers are stored, whereby the entire phone number is able to be dialed at once.

After that, if the telephone card is used up or lost, so the telephone card should be replaced, the user does not need to store the abbreviated numbers again if the user buy a telephone card in which the connect number and the card number is recorded.

For example, even if the user does not buy the telephone card 11 in which the connect number and the card number are recorded, the user only store the connect number and the card number on the telephone card 11 as described above. That is, the contents stored in the respective ROM cards 12˜19 of the first memory unit 5 do not need to be changed.

The present invention is not limited in the embodiments above. That is, when a call from outer country to interior or from another country to the other country is made by memory dialing, the same effects as described above can be obtained by storing the numbers and memory dialing as described above.

Also, in the descriptions above, setting a certain waiting time T1˜T3 when storing a abbreviated number is described for the voice guide message. However, in case that a voice signal is detected by a signal detecting unit 3 and the signal DET is transmitted to the center processor unit 6, the numbers are able to be transmitted within a shorter period, whereby the memory dialing time can be reduced.

In the descriptions above, the telephone card 11 fabricated as same size as that of the ROM card 12˜19. However, the telephone card may be fabricated larger than that of the ROM card as shown in FIG. 3, and a ROM 11B is installed on the telephone card 11A, then the telephone card is able to be used by inserting into a separate inserting unit 11C. In that case, the ROM 11B is connected as same method as that of the ROM cards 11˜19 in the first memory unit 5.

Also, the present invention is not limited to the wire telephone. That is, the present invention is able to be applied to mobile phone. And in that case, when the number of the other is stored or transmitted, only the mobile phone (for example, 01x-xxx-xxxx) number is needed without dialing the local number.

### INDUSTRIAL APPLICABILITY

As so far described, according to the memory dialing method for the telephone, in case that a user make a domestic or an international call, that is, the user should presses many keys, the user is able to make memory dialing conveniently at a low expense. Because an abbreviated number are recorded in the telephone card to thereby directly use the abbreviated dialing or an abbreviated phone number assigning key portion of the phone number and the remaining numbers are stored in the ROM card which is attached and detached to and from a phone set to thereby make an abbreviated dialing.

1. A memory dialing method for a telephone comprising:
a first step inserting a telephone card fabricated so as to be attached and detached to/from the telephone and having a memory concentrated element, and inputting a connect number and telephone card number;
a second step recording the inputted numbers on the memory concentrated element and setting a waiting time for voice guide message; and
a third step reading the numbers recorded in the telephone card on identifying pressing the hot key corresponding the telephone card and generating corresponding DTMF (Dual-Tone Multi Frequency) signal, and transmitting the signal to an exchanger.

2. The method according to claim 1, wherein the first step further comprising a step of inputting a language select number for voice guide message.

3. The method according to claim 1, wherein the third step further comprising a step which reads the numbers recorded in the telephone card and generates corresponding DTMF signal, after that generates DTMF signal corresponding to the telephone number inputted by the user.

4. A memory dialing method for a telephone comprising:
a first step inserting a telephone card having a memory concentrated element and fabricated so as to be attached and detached to/from the telephone, recording connect number of a telecommunication company and the telephone card number in the memory concentrated element on being inputted the numbers by the user, and setting a waiting time for voice guide message;
a second step recording a special key and the phone number of the receiver on a ROM card on being inputted them by the user; and
a third step reading the numbers recorded in the first step based on the special keys recorded in the second step and generating corresponding DTMF signal on identifying pressing the hot key of the ROM card, after that, generating DTMF signal corresponding to the numbers recorded in the second step continually.

5. The method according to claim 4, wherein the telephone is a mobile phone.

6. The method according to claim 4, wherein the special key is one of ‘*’ or ‘#’.

7. The method according to claim 4, wherein the phone number of a receiver includes a country code and local number.

8. The method according to claim 4, wherein the second step further comprising a step of recording the special key and the phone number of the receiver in a memory region except the ROM card on being inputted the special key and the phone number by the user.
